(19) United States
(12) Patent Application Publication
(10) Pub. No.: US 2026/0238081 A1
(43) Pub. Date: Aug. 13, 2026

(54) MAGNETIC HYSTERESIS BRAKE WITH ADJUSTABLE AIR GAP

(71) Applicant: SAFRAN ELECTRONICS & DEFENSE ACTUATION, AUXERRE (FR)

(72) Inventor: Aurélien BELLIER, MOISSY-CRAMAYEL (FR)

(21) Appl. No.: 18/846,927

(22) PCT Filed: Mar. 14, 2023
(86) PCT No.: PCT/EP2023/056436

§ 371 Date: Sep. 13, 2024

(30) Foreign Application Priority Data
Mar. 14, 2022 (FR) FR2202218

(51) Int. Cl. H02K 7/12; G05G 5/04

(52) U.S. Cl. CPC H02K 7/125; G05G 5/04

(57) ABSTRACT

A magnetic hysteresis brake includes an inner element and an outer element which defines a cavity for receiving the inner element such that the inner element and the outer element are rotatable about a pivot axis relative to each other. One of the elements is provided with magnets and the other is made of semi-remanent material such that the magnets generate in the semi-remanent material an induced magnetic field through the opposing surfaces. The brake includes a member for adjusting the axial position of one of the elements relative to the other of the elements in order to adjust a degree of engagement of the inner element into the outer element and therefore an intensity of the induced magnetic field. A control instrument and a vehicle include such a brake.

The present invention relates to a magnetic hysteresis brake which is usable, for example, in human-machine interfaces, to generate a force which is resistant to the movement of an object, such as a control instrument, handled by a user.

### BACKGROUND OF THE INVENTION

The resistant force in question is the result of a magnetic friction exerted on a part connected to the object to be braked.

A magnetic hysteresis brake comprises two facing elements which are movable relative each other, namely a rotor and a stator: one of the elements, for example, the stator has magnetic poles facing the rotor and the rotor is made of a material with high magnetic remanence. It is reminded that such a material has magnetic properties, such that:
when the material is subjected to an excitation magnetic field, a magnetic field is induced in the material, and
when the excitation field varies, the corresponding induced field describes a hysteresis cycle, i.e. that when the excitation field returns to its initial value (zero), the induced field remains (it is said that the material preserves a remanent induction).

Thus, the magnetic poles of the stator generate the activation magnetic field and the induced field in the rotor produces a resistance to the movement of the rotor.

Such magnetic hysteresis brakes are, for example, used in control instruments. The rotor is thus connected to a handle of the control instrument, this handle being moved by a user, for example to control a device such as an engine. The induced magnetic field produces a resistance to the movement of the rotor and therefore a resistance to the movement of the instrument handled by the user. This resistance makes it possible for the user to best determine the movement that they impress on the handle of the control instrument.

Document FR-A-2998347 describes a magnetic brake in which the poles are formed by electromagnetic windings.

The magnetic poles can also be formed by permanent magnets, which makes it possible to have a simpler structure.

However, the resistant force depends on the power of the magnets used and on the air gap between the rotor and the stator. Yet, the sizing and the adjustments necessary to obtain the desired resistant force are relatively complex.

### AIM OF THE INVENTION

The invention aims, in particular, for a magnetic hysteresis brake, the resistant force of which is adapted to the applications considered.

### SUMMARY OF THE INVENTION

To this end, a magnetic hysteresis brake is provided, according to the invention, comprising an inner element having an outer surface centred on a pivot axis and an outer element having an inner surface which is centred on the pivot axis and which defines a cavity for receiving the inner element, such that the inner element and the outer element are rotatable about the pivot axis relative to each other. One of the elements is provided with magnets and the other of the elements is made of semi-remanent material, such that the magnets generate in the semi-remanent material an induced magnetic field through said surfaces when said surfaces opposing each other. The brake comprises a member for adjusting the axial position of one of the elements relative to the other of the elements in order to adjust a degree of engagement of the inner element into the outer element and therefore an intensity of the induced magnetic field.

Thus:
if the inner surface and the outer surface are truncated, the axial offset of the inner element relative to the outer element makes it possible to modify, in particular, the air gap between them (i.e. the distance between the inner surface and the outer surface);
if the inner surface and the outer surface are cylindrical, the axial offset of the inner element relative to the outer element makes it possible to modify the coverage ratio of the inner surface to the outer surface, and therefore the surface available for the passage of the field lines.

It results from this that the adjustment of the axial position of the inner element relative to the outer element makes it possible to adjust the resistant force simply and economically.

The invention also relates to a control instrument equipped with such a brake and a vehicle equipped with such a control instrument.

Other features and advantages of the invention will appear upon reading the description below of a particular and non-limiting embodiment of the invention.

### BRIEF DESCRIPTION OF THE DRAWINGS

Reference will be made to the accompanying drawings, among which:

FIG. 1 is a partial, schematic view of a vehicle cockpit, provided with a control instrument, according to the invention;

FIG. 2 is a diametrical half-sectional, perspective view, of a brake equipping the control instrument, according to a first embodiment of the invention;

FIG. 3 is a cross-sectional, schematic view, of this brake representing the field lines in one of the magnets of the brake;

FIG. 4 is an axial cross-sectional, partial schematic view, of this brake with a first axial positioning of the rotor;

FIG. 5 is an axial cross-sectional, partial schematic view, of this brake with a second axial positioning of the rotor;

FIG. 6 is an axial cross-sectional, partial schematic view, of this brake with a third axial positioning of the rotor;

FIG. 7 is a partial schematic view, along a first axial cutting plane, of this brake;

FIG. 8 is a partial schematic view, along a second axial cutting plane, of this brake;

FIG. 9 is a partial schematic view, along a third axial cutting plane, of this brake;

FIG. 10 is an axial cross-sectional, partial schematic view, of a brake according to a second embodiment of the invention.

### DETAILED DESCRIPTION OF THE INVENTION

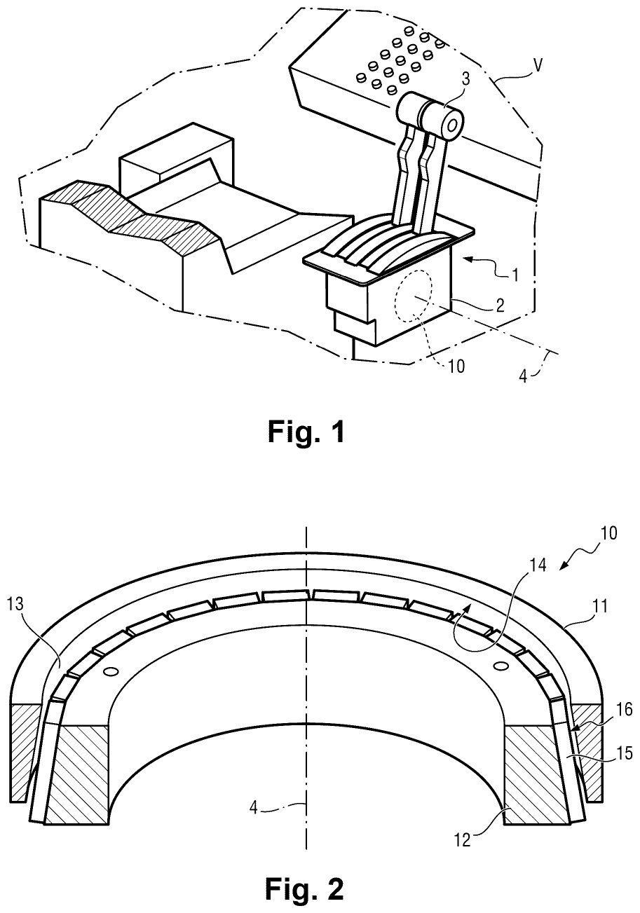

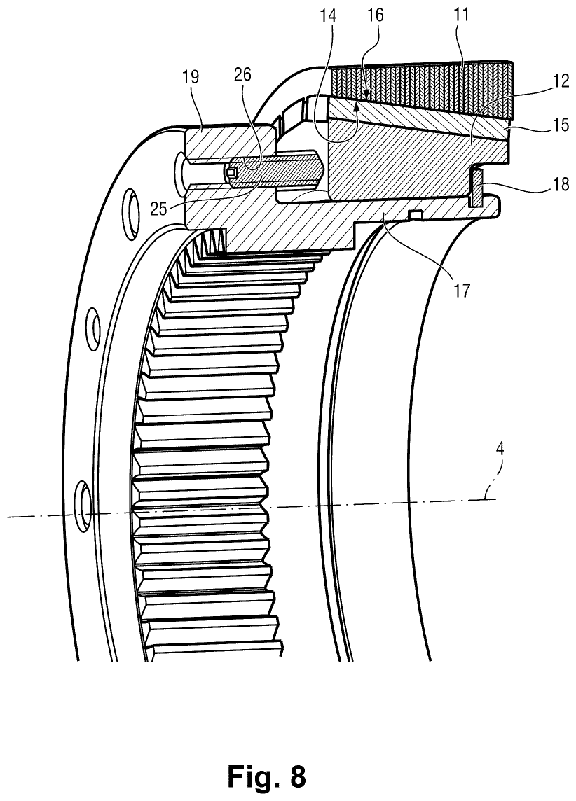

In reference to FIGS. 1 to 9, the invention is, in this case, described in application to a control instrument, generally referenced 1, equipping the cockpit of a vehicle V such as an air, land or naval vehicle. The control instrument 1 is, in this case, arranged to control the engine of said vehicle (the control instrument 1 is, in this case, what is commonly called the throttle).

The control instrument 1 comprises a frame 2 which is fixed to the structure of the vehicle, in the cockpit, within the driver's hand's reach.

A handle 3 is mounted on the frame 2 to pivot about a pivot axis 4, in this case, horizontal.

The control instrument 1 further comprises a brake 10 comprising a stator 11 rotatably connected to the frame 1 and a rotor 12 rotatably connected to the handle 3.

The brake 10 is a magnetic hysteresis brake.

The stator 11 is formed of a stack of sheets which are stacked along the pivot axis 4 and are each pierced with a hole so as to form a cavity 13 defined by an inner surface 14 of the stack of sheets forming the stator 11. inner surface 14 is truncated-shaped centred on the pivot axis 4. The sheets are made of a semi-remanent material. The material chosen for the stack of sheets of the cylinder head is called “semi-remanent” as its major hysteresis cycle is close to that of a magnet. The material is, for example, that produced under the trademark MAGNETOFLEX (and more specifically, MAGNETOFLEX 35 U) or CROVAC, by the manufacturer VACUUMSCHMELZE.

The rotor 12 comprises a steel, tubular hub, which is centred on the pivot axis 4 and which has a truncated peripheral surface on which magnets 15 are fixed. The magnets 15 are positioned such that their magnetisation vector extends along a radial direction of the hub and are alternately oriented north-south and south-north along a circumferential direction of the hub. Thus, along this circumferential direction, the north pole of a magnet 15 is sandwiched by the south poles of the two adjacent magnets 15, and so on, to form magnetisation poles alternating over an outer surface 16 of the rotor 12.

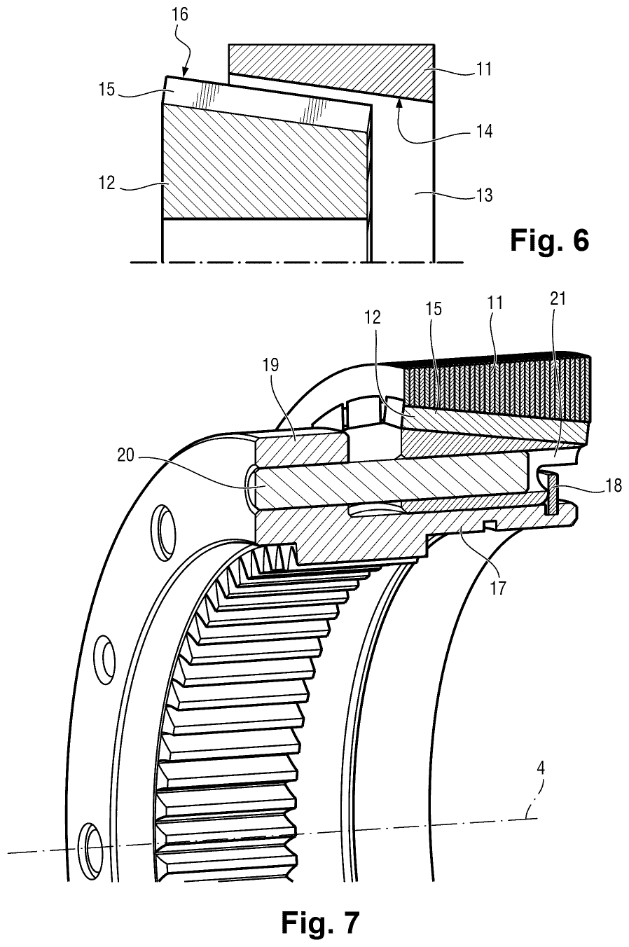

The rotor 12 and the stator 11 are mounted movable relative to each other to be not only rotatable about the pivot axis 4, but also translatable along the pivot axis 4. To this end, the hub of the rotor 12 is mounted to slide axially over a tubular shaft 17 rotatably connected, in this case, via an inner gearing, to the handle 3 and mounted in the frame 2 to pivot about the pivot axis 4. The amplitude of the translation movement of the hub 12 is such that the rotor 12 and the stator 11 have two extreme relative positions:
a maximum engagement position, in which the rotor 12 is received in the housing 13 of the stator 11 and bears against a front abutment 18 (in this case, a stop ring) secured to the tubular shaft 17, such that the inner surface 14 and the outer surface 16 extend opposite each other with a minimum air gap between them (see FIG. 4);
a minimum engagement position, in which the rotor 12 is partially released from the inner surface 14 of the housing 13 of the stator 11 and is close to a collar 19 secured to the tubular shaft 17, such that the inner surface 14 and the outer surface 16 are offset relative to each other with a maximum air gap between them (see FIG. 6).

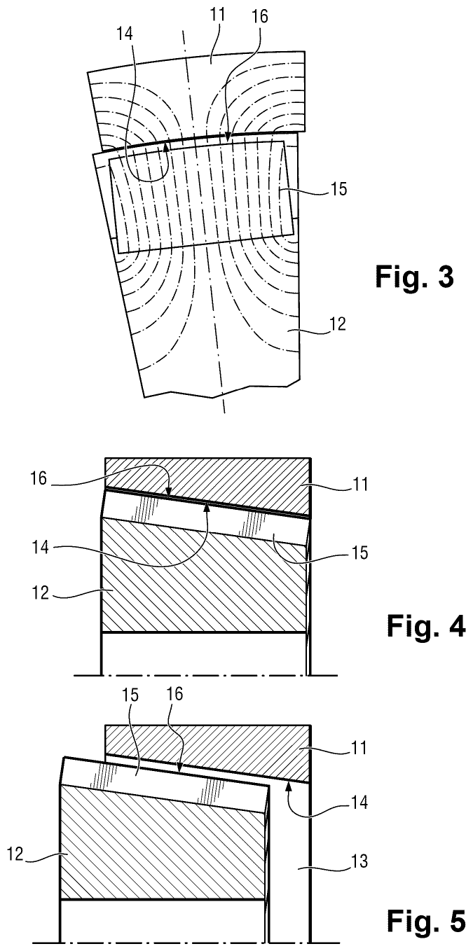

An intermediate position has also been represented in FIG. 5. It will be noted that the engagement depth of the rotor 12 in the stator 11 also conditions the area of the outer surface 16 opposite the inner surface 14, and therefore the coverage ratio of these two surfaces. It is reminded that the coverage ratio of the two surfaces is representative the passage cross-section available for the field lines (the field lines have been represented in FIG. 3). Thus, the more the rotor 12 is engaged in the stator 11, the greater the resistance to the pivoting of the rotor 12 will be.

The rotor 12 is rotatably connected to the shaft 17 and translatably guided through pins 20, each extending parallel to the pivot axis 4 and each having an end section embedded in the collar 19 and an end section received in a bore 21 of the rotor 12 sliding parallel to the pivot axis 4 (see FIG. 7). There are three pins 20, in this case, and are symmetrically disposed about the pivot axis 4.

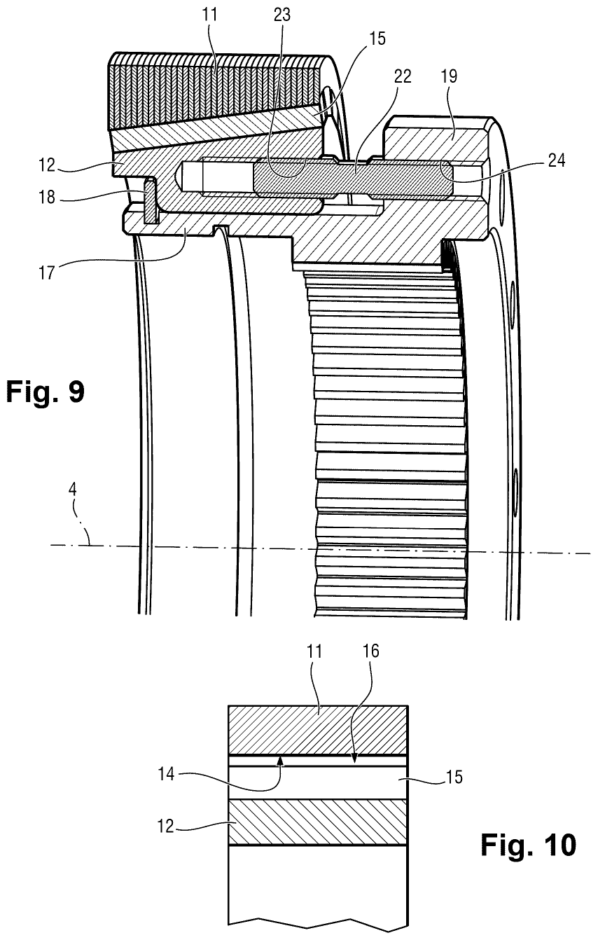

The positional adjustment of the rotor 12 along the pins 20 is ensured through two screws 22 which extend parallel to the pivot axis 4 in two diametrically opposite positions (see FIG. 9 or only one of the screws can be seen). Each screw 22 comprises two end sections threaded in opposite directions and engaged respectively for one in the thread 23 of the rotor 12 and for the other, in a thread 24 of the collar 19. The rotation of the screws 22 moves the rotor 12 closer to or away from the collar 19 according to the rotation direction.

The locking of the adjustment in the axial position is ensured by needle screws 25 engaged in the threads 26 of the collar 19 to project from the collar 19 and bear against the rotor 12. When the needle screws 25 are tightened against the rotor 12, they stress the screws 22 and prevent them from loosening once the adjustment in the axial position has been carried out.

In view of FIG. 3, it is understood that the stream lines of the magnetic field generated by the magnets 15 pass through the surfaces 16 and 14 and close in the stator 11 to induce a magnetic field there. Under the effect of the rotation of the rotor 12 relative to the stator 11, the semi-remanent material of the stator 11 will therefore behave like a magnet and generate a statoric magnetic field opposing the rotoric magnetic field in the air gap: this opposing of the fields will create a dry friction torque, the value of which does not depend on the rotation speed. This dry friction produces a resistance to the relative pivoting of the rotor 12 and of the stator 11.

Between the two extreme positions, it is understood that there are intermediate position in which the magnetic friction is present, but is lesser than in the maximum engagement position, the magnetic friction increasing as it moves away from the minimum engagement position and moves closer to the maximum engagement position.

In the embodiment of FIG. 10, the surfaces 14 and 16 are cylindrical and centred on the pivot axis 4.

As above, the rotor 12 is adjustable in the axial position relative to the stator 11 between two extreme relative positions:
a maximum engagement position, in which the rotor 12 is received in the housing 13 of the stator 11 and bears against an abutment 18 (in this case, a stop ring) secured to the tubular shaft 17, such that a maximum of the inner surface 14 is located opposite the outer surface 16;
a minimum engagement position, in which the rotor 12 is partially released from the inner surface 14 of the housing 13 of the stator 11 and is close to a collar 19 secured to the tubular shaft 17, such that a minimum of the inner surface 14 is located opposite the outer surface 16.

It will be noted that, in this embodiment, the air gap does not depend on the engagement depth of the rotor 12 in the stator 11. Only the coverage ratio of the two surfaces 14, 16 is modified.

Naturally, the invention is not limited to the embodiments described, but includes any variant entering into the scope of the invention such as defined by the claims.

In particular, the brake can have a different structure from that described above.

The handle of the control instrument can, for example, be a button, a wheel, a lever, or other. The invention is also applicable to controlling flight controls, and more generally, for any device needing to implement a dry friction.

The stator can constitute the inner element and the rotor can constitute the outer element.

The stator can be rotatably fixed and translatable, while the rotor is rotatable and translatably fixed.

The rotor can have the shape of a solid cylinder and not a hollow hub.

The stator can carry the magnets and the rotor can be made of semi-remanent material.

The locking in position of the hub on the shaft can be obtained by tightening the hub of the shaft (tightening by screwing or keying, for example), or by any other locking means. There can be one or more locking means.

There can be one or more members for adjusting in position.

The adjustment in position can result from the sliding of the rotor 12 on the shaft 17, but also from the screwing of the rotor 12 on the shaft 17.

1. A magnetic hysteresis brake, comprising an inner element having an outer surface centred on a pivot axis and an outer element having an inner surface which is centred on the pivot axis and which defines an housing for receiving the inner element, such that the inner element and the outer element are rotatable about the pivot axis to each other, one of the elements being provided with magnets and the other of the elements being made of semi-remanent material, such that the magnets generate in the semi-remanent material an induced magnetic field through said surfaces when said surfaces oppose each other, the brake comprising a member for adjusting in the axial position of one of the elements relative to the other of the elements in order to adjust a degree of engagement of the inner element into the outer element and therefore an intensity of the induced magnetic field and at least one from among the inner element and the outer element being adjustable in position and mounted to slide on a shaft, wherein the member for adjusting in the axial position comprises at least one screw which extends parallel to the pivot axis and which comprises two end sections threaded in opposite directions and engages respectively in a thread of the inner element carried by the shaft and, for the other, in a thread of a collar of the shaft and a locking of the adjustment in the axial position is ensured by needle screws engaged in threads of the collar to project from the collar and bear against the element mounted on the shaft.

2. The brake according to claim 1, wherein the inner surface and the outer surface are truncated surfaces having respective axes aligned on the pivot axis.

3. The brake according to claim 1, wherein the inner surface and the outer surface are cylindrical surfaces having generators extending parallel to the pivot axis.

4. The brake according to claim 1, wherein the element carried by the shaft is rotatably connected to the shaft and translatably guided through pins, each extending parallel to the pivot axis and each having an end section embedded in a collar of the shaft.

5. A control instrument comprising a frame, an handle mounted to pivot on the frame, and the brake according to claim 1, one of the inner element and the outer element of the brake being rotatably connected to the frame and the other of the inner element and of the outer element of the brake being rotatably connected to the handle.

6. A vehicle comprising the control instrument according to claim 5.
